(19) United States
(12) Patent Application Publication
(10) Pub. No.: US 2009/0009725 A1
(43) Pub. Date: Jan. 8, 2009

(54) PROJECTION SYSTEM, OPTICAL SYSTEM THEREOF AND PROJECTING METHOD THEREOF

(75) Inventors: Kang-Yuan Lee, Taichung (TW); Yuan-Hsu Chou, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/167,281

(22) Filed: Jul. 3, 2008

(30) Foreign Application Priority Data
Jul. 3, 2007 (TW) 96124099

(51) Int. Cl. G03B 21/14

(52) U.S. Cl. 353/31; 353/84

(57) ABSTRACT

An optical system for a projector is provided, including a light source generating laser beams, a transforming sheet, a panel, and a lens set. Laser beams from planar light sources penetrate the transforming sheet and are uniformly transformed to be rectangular beams, acting as light beams from a planar light source. The rectangular laser beams pass through the panel to generate an image which is projected to a screen by the lens set.

### BACKGROUND OF THE INVENTION

1. Field of the Invention

The invention relates to an optical system for a projector, and in particular, relates to an optical system employing laser sources for a projector.

2. Description of the Related Art

Since conventional projectors use ultra high performance (UHP) lamps as their light sources, they have poor color performance and low lamp service life. In addition, the UHP lamps must be used along with filter lens, matrix lens, polarity converters, certain lens groups, light split systems, and light combination systems to generate uniform R, G, B light beams. Certain high-cost optical elements are needed, which also causes complicated assembly procedure and considerable volume.

### BRIEF SUMMARY OF INVENTION

An embodiment of an optical system of the invention comprises a light source generating laser beams, a transforming sheet, a panel, and a lens set. The laser beams penetrate the transforming sheet and to be transformed to a rectangular beam, acting as light beams from a planar light source, and the rectangular light beams pass through the panel to generate an image which is projected to a screen by the lens set.

The laser beams from the light source comprise a first color laser beam and a second color laser beam.

The optical system comprises a first mirror reflecting the first color laser beam to an optical path, and a first filter allowing penetration of the first color laser beam and guiding the first color laser beam to the transforming sheet and reflecting the second color laser beam to the transforming sheet.

The laser beams further comprise a third color laser beam.

The optical system further comprises a second filter disposed in the optical path allowing penetration of the first and second color laser beams and reflecting the third color laser beam, wherein the first and second color light beams pass through the second filter and is mixed with the third color laser beam, and a second mirror reflects the mixed first, second an third color laser beams to the transforming sheet.

A detailed description is given in the following embodiments with reference to the accompanying drawing.

### BRIEF DESCRIPTION OF DRAWINGS

The invention can be more fully understood by reading the subsequent detailed description and examples with references made to the accompanying drawing, wherein:

FIG. 1 is a schematic view of an optical system for a projector of the invention.

### DETAILED DESCRIPTION OF INVENTION

The invention discloses a projector with red, green and blue laser sources. The laser beams diverge by penetrating a transforming sheet. The rectangular laser beams act as laser beams emitted from a planar light source. The rectangular laser beams pass through a diffusion sheet to become uniformly diffused laser beams. The diffused laser beams pass through a panel to generate an image which is projected by a lens set. The diffusion sheet is moved by a reciprocating mechanism to eliminate speckle caused by laser sources.

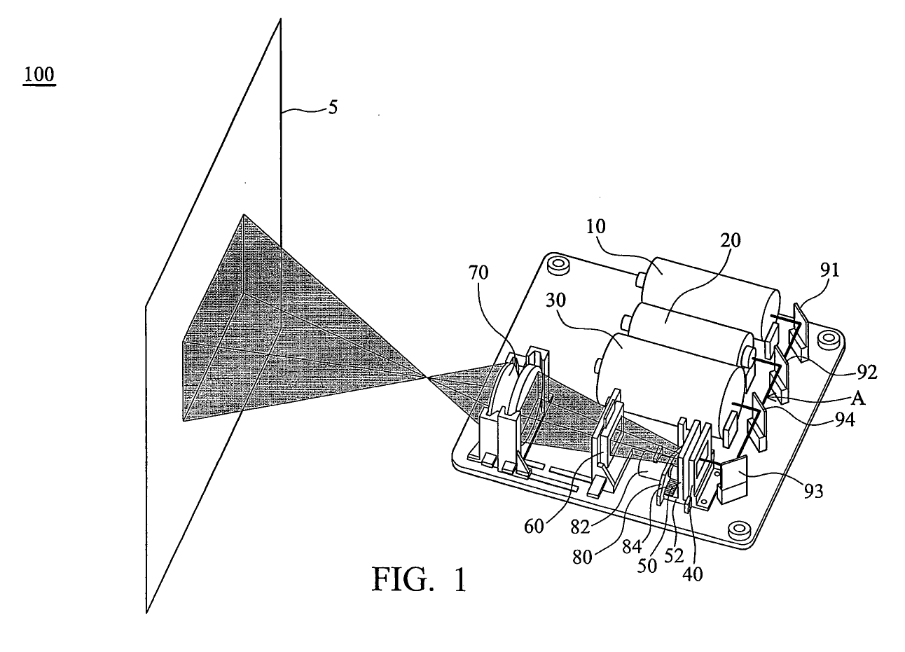

An optical system 100 for a projector, shown in FIG. 1, comprises a first laser source (green light) 10, a second laser source (red light) 20, a third laser source (blue light) 30, a transforming sheet 40, a diffusion sheet 50, a panel 60, a lens set 70, a reciprocating mechanism 80, a first mirror 91, a second mirror 93, a first filter 92 and a second filter 94.

A green laser beam (first color laser beam, first laser beam) from the first laser source 10 is reflected to an optical path A by the first mirror 91. The green laser beam propagates along the optical path A and penetrates the first filter 92. A red laser beam (second color laser beam, second laser beam) from the second laser source 20 is reflected to the optical path A by the first filter 92 and is mixed with the green laser beam. The mixed green and red laser beams penetrate the second filter 94. A blue laser beam (third color laser beam, third laser beam) from the third laser source 93 is reflected to the optical path A and is mixed with the green and red laser beams as a mixed laser beam. The mixed laser beam is reflected by the second mirror 93 to reach the transforming sheet 40. The mixed laser beam penetrates the transforming sheet 40 and diverges. The rectangular laser beam with a rectangular cross section acts as if it was emitted from a planar light source. The rectangular laser beams pass through the diffusion sheet 50 for uniform diffusion. The diffusion sheet is driven by the reciprocating mechanism 80 to move the diffusion sheet 50 along a direction perpendicular to the propagating direction of the diffused laser beam (perpendicular to the normal line of the transforming sheet 40), whereby the speckle inherently caused by the laser source 10 is eliminated.

The diffused laser beam passes through the panel 60 to form an image which is projected to a screen 5 by the lens set 70.

The panel 60 comprises a liquid crystal device through which the diffused laser beam passes to generate the image. In another embodiment of the invention, the panel 60 comprises a digital micro-lens device (DMD) by which the diffused laser beam is reflected to generate the image.

The reciprocating mechanism 80 comprises a motor 82 and a rack 84 disposed on a seat 52 for the diffusion sheet 50. A gear (not shown) is joined to a shaft of the motor 82. When the motor 82 rotates, the gear moves the rack 84 to further move the seat 52, whereby the diffusion sheet 50 fixed to the seat 52 moves.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical system, comprising:
a light source generating laser beams;
a transforming sheet;
a panel; and
a lens set, wherein
the laser beams penetrate the transforming sheet to be transformed to a rectangular beam, acting as a planar light source, and the rectangular laser beams pass through the panel to generate an image which is projected to a screen by the lens set.

2. The optical system as claimed in claim 1, wherein the laser beams from the light source comprise a first color laser beam and a second color laser beam.

3. The optical system as claimed in claim 2 further comprising:
a first mirror, reflecting the first color laser beam to an optical path; and
a first filter, allowing penetration of the first color laser beam and guiding the first color laser beam to the transforming sheet, and reflecting the second color laser beam to the transforming sheet.

4. The optical system as claimed in claim 3, wherein the laser beams further comprises a third color laser beam.

5. The optical system as claimed in claim 4 further comprises:
a second filter, disposed in the optical path allowing penetration of the first and second color laser beams and reflecting the third color laser beam, wherein the first and second color light beams pass through the second filter and is mixed with the third color laser beam; and
a second mirror, reflecting the mixed first, second and third color laser beams to the transforming sheet.

6. The optical system as claimed in claim 1 further comprising a diffusion sheet to uniformly diffuse the rectangular laser beams, and a reciprocating mechanism moving the diffusion sheet along a direction perpendicular to the normal line of the transforming sheet.

7. The optical system as claimed in claim 1, wherein the panel comprises a liquid crystal device allowing penetration of the rectangular laser beams.

8. The optical system as claimed in claim 1, wherein the panel comprises a digital micro-lens device to reflect the rectangular laser beams.

9. A projection system, comprising:
a light source, generating a first laser beam and a second laser beam;
a transforming sheet, transforming the first laser beam and the second laser beam to be rectangular beams;
a diffusion sheet, uniformly diffusing the diverged first and second laser beams;
a lens set; and
a panel, receiving the diffused first and second laser beams to generate an image which is projected to a screen by the lens set.

10. The projection system as claimed in claim 9 further comprising:
a first mirror, reflecting the first laser beam to an optical path; and
a first filter, allowing the first laser beam to penetrate and guiding the first color laser beam to the transforming sheet and reflecting the second laser beam to the transforming sheet.

11. The projection system as claimed in claim 10, wherein the light source further generates a third laser beam.

12. The projection system as claimed in claim 11 further comprising:
a second filter, disposed in the optical path allowing penetration of the first and second laser beams and reflecting the third laser beam, wherein the first and second laser beams pass through the second filter and is mixed with the third laser beam; and
a second mirror, reflecting the mixed first, second and third laser beams to the transforming sheet.

13. The projection system as claimed in claim 9 further comprises a reciprocating mechanism moving the diffusion sheet along a direction perpendicular to the normal line of the transforming sheet.

14. The projection system as claimed in claim 9, wherein the panel comprises a liquid crystal device allowing penetration of the rectangular laser beams, or a digital micro-lens device to reflect the rectangular laser beams.

15. A projecting method of a projection system, comprising the following steps:
providing a laser source;
providing a transforming sheet, transforming laser beams from the laser source to be rectangular laser beams;
providing a diffusion sheet, diffusing the rectangular laser beams; and
moving the diffusion sheet in a plane.

16. The projecting method as claimed in claim 15 further comprising the following step:
providing a reciprocating mechanism, to move the diffusion sheet along a direction perpendicular to the normal line of the transforming sheet.

17. The projecting method as claimed in claim 15 further comprising the following steps:
providing a panel, converting the diffused laser beams into an image; and
projecting the image to a screen by a lens set.

18. The projecting method as claimed in claim 15, further comprising a laser source providing a first laser beam, a second laser beam and a third laser beam.

19. The projecting method as claimed in claim 18 further comprising the following steps:
providing a first mirror, to reflect the first laser beam;
providing a first filter, allowing penetration of the first laser beam and reflecting the second laser beam;
providing a second filter, allowing penetration of the first and second laser beams and reflecting the third laser beam; and
providing a second mirror, reflecting the first, second and third laser beams.

20. The projecting method as claimed in claim 19, wherein the first laser beam is a green laser beam, the second laser beam is a red laser beam, and the third laser beam is a blue laser beam.
